(19) United States
(12) Patent Application Publication
(10) Pub. No.: US 2018/0340590 A1
(43) Pub. Date: Nov. 29, 2018

(54) NET FASTENER DEVICE AND KIT AND METHOD FOR USING SAME

(71) Applicants: Nicholas Aaron Giugovaz, Calgary (CA); Emma Elizabeth Pope, Calgary (CA)

(72) Inventors: Nicholas Aaron Giugovaz, Calgary (CA); Emma Elizabeth Pope, Calgary (CA)

(21) Appl. No.: 15/974,900

(22) Filed: May 9, 2018

Related U.S. Application Data
(60) Provisional application No. 62/512,143, filed on May 29, 2017.

(30) Foreign Application Priority Data
May 29, 2017 (CA) 2968564

(51) Int. Cl. F16G 11/04; A63B 63/00

(52) U.S. Cl. CPC F16G 11/046; A63B 63/004

(57) ABSTRACT

A net fastener for releasably fastening a net to a horizontal crossbar includes a hook defining a loop, the hook having a free end and a handle end defining an opening leading to the loop, an elongate handle extending from the handle end of the hook, a first engagement element proximate the handle end of the hook and a second engagement element located on the handle and separated from the first engagement element by a length of the handle. The first engagement element engages a vertical cord and/or a first horizontal cord of the net and the second engagement element engages a second horizontal cord and/or the vertical cord of the net, and the hook engages the horizontal crossbar. A method for using a plurality of net fasteners to fasten a net to a horizontal crossbar, and a kit comprising a plurality of net fasteners, are also provided.

### CROSS REFERENCE TO RELATED APPLICATIONS

This application claims priority from U.S. Provisional Patent Application No. 62/512,143, filed on May 29, 2017, entitled “NET FASTENER DEVICE AND KIT AND METHOD FOR USING SAME” and Canadian Patent Application No. 2,968,564, filed on May 29, 2017, entitled “NET FASTENER DEVICE AND KIT AND METHOD FOR USING SAME”, entireties of which are incorporated herein by reference.

### FIELD

Devices, kits and methods for fastening a net to a net frame; in particular, devices, kits and methods for releasably fastening a net to a net frame having a horizontal crossbar.

### BACKGROUND

Nets are often utilized for various types of sports, typically to define a cavity which serves as a goal or target for games in which the objective is to move a ball, or other object, into the goal. A typical example includes a soccer net, which is normally fastened to a net frame consisting of at least a horizontal crossbar, the crossbar supported approximately 8 feet off the ground by two vertical supports mounted to either end of the crossbar.

Because nets are manufactured of cords which will wear over time, requiring replacement, soccer nets are typically removably fastened to the net frame. The net is fastened to the horizontal crossbar and vertical supports of the frame by using releasable fasteners, such as hook-and-loop strips, adhesive tape, elastic cords and the like. The bottom edge of the net may be secured to the ground using stakes, or to a bottom portion of the frame using fasteners such as tape or hook-and-loop strips.

In the case of soccer nets, because the horizontal crossbar is typically supported at a distance of eight feet above the ground, the person who is hanging the soccer net must usually use a ladder, an overturned pail, or even a fellow soccer player, to boost themselves off the ground in order to reach the crossbar. As most fasteners usually require two hands to manipulate, installing the net on the crossbar usually requires two people, with one person on the ground supporting the second person standing on an object to reach the crossbar. The net is usually fastened at several points along the crossbar, to reduce sagging of the net relative to the crossbar, further adding to the time it takes to complete installation of the net. Furthermore, once the game or practice is finished and the net is no longer required, the process must be repeated to boost a person upwardly, in order to remove the net from the horizontal crossbar by releasing the plurality of fasteners.

Because the process of fastening a net to a soccer net frame is a time consuming and possibly dangerous activity, due to the challenges described above, nets are often not hung during practices, reducing practice quality due to the players having to chase and retrieve balls during shooting drills. Games or practices often start late because the tall player or the player with the ladder or other boosting object does not arrive on time. A further consequence is that nets, when they are installed, are often poorly fastened to the net frame, due to an insufficient number of fastening points used along the crossbar, thereby causing the net to sag and creating gaps between the net and the crossbar.

In prior art of which the applicant is aware, there are disclosed various devices for fastening nets or other objects to horizontal crossbars. For example, in European patent no. 2605841, there is disclosed a portable target for use with a soccer goal, having a flexible frame with longitudinal side walls, channels adjacent the longitudinal side walls which are open at the top end and closed at the bottom end, and elongate connecting rods having connecting members retained at the top of the connecting rods, the connecting members terminating in hooks for engaging with the horizontal crossbar of the soccer net frame. The connecting rods are retained in the channels, with the hooks protruding from the top, open ends of the channels, and the flexible target frame is supported between the two connecting rods retained in the channels. Once installed on the crossbar, the flexible target extends vertically towards the ground.

In US patent publication no. 2011/0059815, there is disclosed an attachable soccer rebound net that may be attached to a soccer goal frame. The rebound net includes attachment means for attaching the top edge of the rebound net to the horizontal crossbar of the net frame, the attachment means comprising a plurality of hooks. The net is attached to the hook by a zip tie or clip mechanism. In some embodiments, the hooks may include a post which may be fitted into an opening on a separate pole, so that the pole may be used to lift the hooks to the crossbar; the pole may be in the range of three to five feet in length. Once installed on the net frame, the rebound net covers the opening defined by the net frame.

In U.S. Pat. No. 8,096,903, there is disclosed a device for connecting a soccer net to the horizontal crossbar of a soccer goal and method for using same. The device includes a resilient clip having an inner surface which is shaped and dimensioned to receive a horizontal crossbar, and a line attached to the clip which is long enough to be thrown over the crossbar and pulled down. The clip is attached to an edge of the net, the line is thrown over the crossbar and pulled down, raising the clip and net to the crossbar until the mouth of the clip is facing downward over the crossbar. The net and line are then pulled down simultaneously, forcing the mouth of the resilient clip to open, receive and clamp onto the horizontal crossbar.

In U.S. Pat. No. 8,439,775, there is disclosed a soccer training apparatus and method, the apparatus having a net sized to cover a portion of the goal opening, and a coupling device having a J-shaped housing with an end section and a leg section, the leg section having a hollow interior and the end section positionable over a crossbar. An elastic member is partially disposed within the housing and has an outer end with a fastener protruding from the housing. The fastener couples with an eyelet attached to the net. The coupling device may further include a finger extending from the leg portion, for coupling with a second eyelet attached to the net. The elastic member is moveable between a retracted position and an extended position, so that when the elastic member is in the extended position, it exerts a force on the net attached to the fastener, bringing the net towards the crossbar. Once installed on the crossbar, the net extends vertically towards the ground.

### SUMMARY

To facilitate releasably securing a net to a horizontal crossbar of a net frame, a net fastener having a hook, a handle extending from the hook, and two attachment points or engagement elements for engaging the net fastener to a cord of the net, is disclosed herein. To secure a net to the horizontal crossbar, each net fastener of a plurality of net fasteners is first engaged to the net, by engaging each engagement element of each net fastener with one or more cords of the net. Once the cords of the net are engaged in each of the two engagement elements of each net fastener, the hook of each net fastener engages the horizontal crossbar. The elongate handle facilitates engaging the hooks of the net fasteners with a horizontal crossbar that may be a distance from the ground that is greater than the average height and arm reach of a person; for example, typical soccer net frames may have horizontal crossbars that are approximately eight feet above the ground.

Advantageously, the two separate engagement elements on each net fastener, which each engage a horizontal and/or vertical cord of the net, assist with stabilizing the net on the horizontal crossbar. In the Applicant's experience, a single engagement element on the net fastener is insufficient to maintain the net fastener in place on the horizontal crossbar because impacts to the net, once mounted on the crossbar, such as impacts from a ball kicked into the net by a player, may cause the net fastener to move out of place, possibly resulting in the net sagging along the crossbar. The addition of the second engagement element, spaced apart from the first engagement element by a length of the handle, may in some embodiments enable a single vertical cord to be engaged in each of the first and second engagement elements, which adds to the lateral stability of the net by supporting the same vertical cord in two places along the net fastener. The net may be further stabilized by staking an edge of the net to the ground, the staked net edge being opposite the net edge supported on the horizontal crossbar.

In one aspect of the present disclosure, a net fastener for releasably fastening a net to a horizontal crossbar is provided. In one aspect, the net fastener has a hook defining a loop, the hook having a free end and a handle end defining an opening leading to the loop. The fastener also includes an elongate handle extending from the handle end of the hook, a first engagement element located proximate the handle end of the hook and a second engagement element separated from the first engagement element by a length of the handle. In use, the first engagement element engages a vertical cord and/or a first horizontal cord of the net and the second engagement element engages a second horizontal cord and/or the vertical cord of the net.

In another aspect of the present disclosure, a method for releasably fastening a net to a horizontal crossbar is provided. Such a method may include the steps of: engaging a first engagement element of each fastener of a plurality of net fasteners with a peripheral horizontal cord of the net; engaging a second engagement element of each fastener with a second cord of the net, the second cord vertically spaced apart from the peripheral horizontal cord; and engaging a hook of each net fastener with the horizontal crossbar.

In still another aspect of the present disclosure, a kit for releasably fastening a net to a horizontal crossbar of a net frame is provided. In some embodiments, the kit includes at least five net fasteners, each net fastener having a hook, an elongate handle extending from the hook, a first engagement element proximate a junction between the hook and the handle, and a second engagement element separated from the first engagement element by a length of the handle.

### BRIEF DESCRIPTION OF THE DRAWINGS

FIG. 1 is a perspective view of an embodiment of the net fastener;

FIG. 1A is a close-up view of the first engagement element of the net fastener illustrated in FIG. 1;

FIG. 2 is a side elevation view of the net fastener illustrated in FIG. 1;

FIG. 3 is a front elevation view of the net fastener illustrated in FIG. 1;

FIG. 4 is a rear elevation view of a net mounted to a horizontal crossbar utilizing a plurality of the net fasteners illustrated in FIG. 1; and

FIG. 5 is a front elevation close-up view of the net fastener illustrated in FIG. 1 engaging a portion of a horizontal crossbar.

### DETAILED DESCRIPTION

In one aspect of the present disclosure, a net fastener is provided which facilitates the hanging and supporting of a net on a horizontal crossbar that is elevated above the ground, without requiring a ladder or other support to reach the crossbar. In another aspect of the present disclosure, a method for hanging a net on a horizontal crossbar and removing the net from the crossbar, utilizing a plurality of net fasteners, is provided. In yet another aspect of the present disclosure, a kit for hanging and supporting a net from a horizontal crossbar, using a plurality of net fasteners, is provided. As used herein, the word “net” includes both traditional nets having horizontal cords and vertical cords that are substantially perpendicular to the horizontal cords, such as the type of nets typically used for playing soccer, but also includes other types of nets, such as lacrosse nets and hockey nets, and similar objects including targets, tarps and dividers. It will also be appreciated by a person skilled in the art that the net fasteners described herein may also be used to support other types of objects from horizontal crossbars, including and not limited to lights.

An embodiment of the net fastener 10 disclosed herein includes a hook 20, the hook 20 having a free end 22 and a handle end 24. Extending from the handle end 24 of hook 20 is an elongate handle 30. At a junction 26 between the hook 20 and handle 30 is a first engagement element 40 for engaging with a cord of the net. The handle 30 includes a distal end 32, distal from the hook 20. The distal end 32 of the handle 30 includes a second engagement element 50 for engaging with a cord of the net.

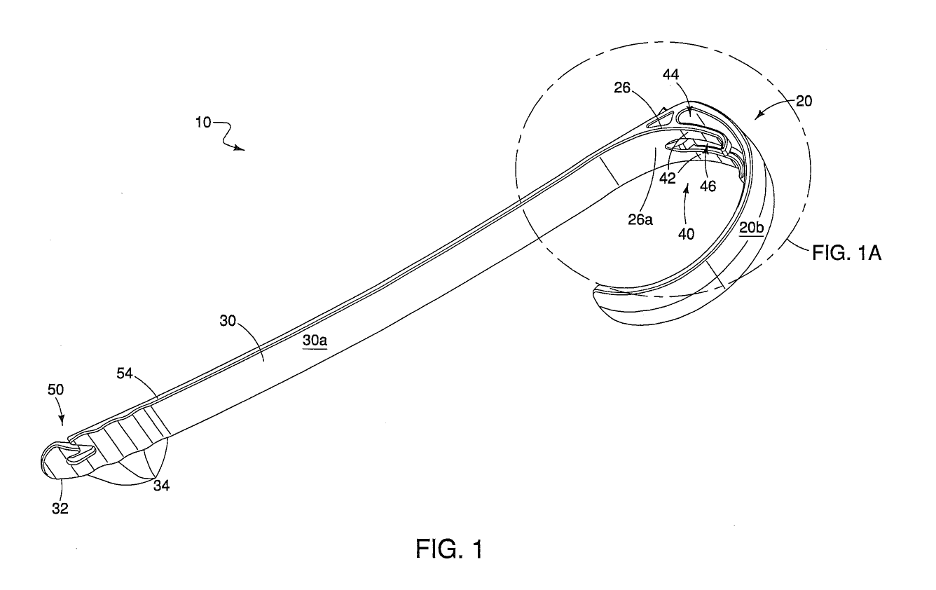

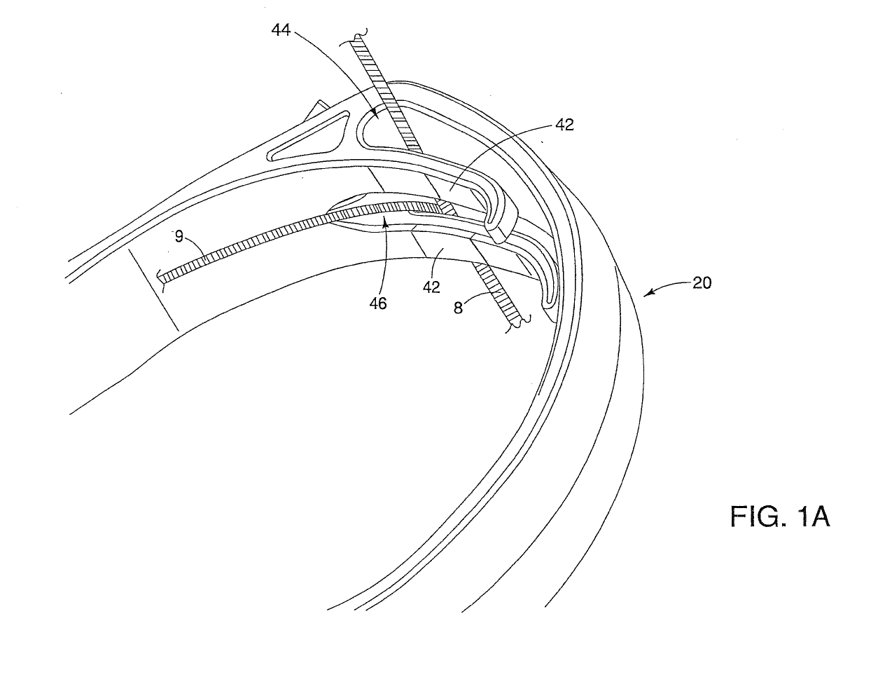

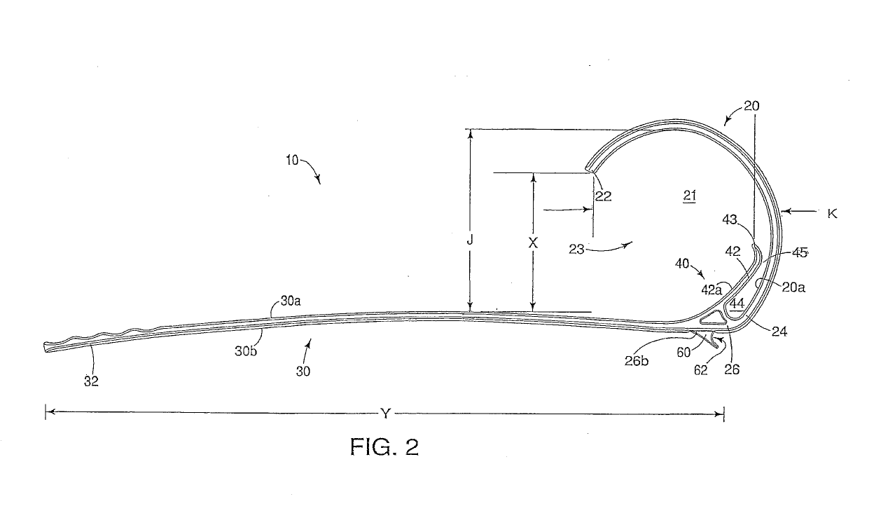

Referring in particular to FIGS. 1 and 2, the first engagement element 40, in some embodiments, may include one or more prongs 42 extending from, or proximate to, the junction 26 between handle 30 and hook 20. In a preferred embodiment, two prongs 42, 42 may protrude from an interior surface 26a of the junction 26 and extend towards the open loop 21 and away from the handle 30 and toward the hook 20, thereby forming a first gap 44 between the interior surface 20a of the hook 20 and the prongs 42, 42. In some embodiments, the prongs 42, 42 may include free ends 43, 43 which curve slightly away from hook 20, thereby forming a neck 45 leading to the first gap 44. In some embodiments, the first gap 44 receives a horizontal cord of the net 7. (As used herein, a “horizontal cord” of the net refers to cords running substantially parallel to the horizontal crossbar when the net 7 is mounted to crossbar 5, and a “vertical cord” of the net 7 refers to cords running substantially perpendicular to the crossbar when the net 7 is mounted to crossbar 5).

In some embodiments, the horizontal cord of the net received in gap 44 of first attachment element 40 may be a peripheral horizontal cord 8 of net 7, which runs along the periphery of the net. Engaging the peripheral horizontal cord 8 of the net 7 in first gap 44 advantageously positions the peripheral horizontal cord 8 of net 7 against a rear surface 5a of the horizontal crossbar 5 when the net fastener 10 is engaged on the crossbar 5, thereby allowing the rest of the net 7 to suspend downwardly from behind the crossbar 5; however, it will be appreciated by persons skilled in the art that other horizontal cords of the net 7 may be engaged in first engagement element 40 of net fastener 10.

Advantageously, in some embodiments the neck 45 of first gap 44 may assist in retaining the horizontal cord 8 of net 7 within first gap 44 by making it more difficult for horizontal cord 8 to escape first gap 44 once engaged. Furthermore, for embodiments in which the net fastener 10 (or portions thereof) is manufactured of a resilient material, the prongs 42, 42 of first engagement element 40 may be resilient such that when the crossbar 5 is received within open loop 21, a rear surface 5a of crossbar 5 engages an outer surface 42a of prongs 42, 42, thereby slightly urging the free ends 43, 43 of prongs 42, 42 towards the interior surface 20a of hook 20 and thereby further narrowing neck 45. Such compression may occur, for example, as a result of the tension of the net 7 as a result of staking net 7 to the ground beneath the horizontal crossbar 5, or the compression of the loop 20 around crossbar 5, or a combination of these forces acting on net fastener 10. The urging of free ends 43, 43 of prongs 42, 42 towards the interior surface 20a of hook 20 to further narrow the neck 45 additionally assists with retaining one or more horizontal cords 8 of the net 7 within first gap 44.

In a preferred embodiment of the present disclosure, in addition to a peripheral horizontal cord 8 (or other horizontal cord) of net 7 being retained in first engagement element 40, in some embodiments the first engagement element further engages a second cord of the net, such as a vertical cord 9 of net 7. As best seen in FIGS. 1 and 1A, the prongs 42, 42 may be substantially parallel to and spaced apart from each other, thereby forming a second gap 46 between prongs 42, 42, and a vertical cord 9 may be received in second gap 46 formed between prongs 42, 42. Advantageously, a first engagement element 40 which engages both a horizontal cord 8 and a vertical cord 9 of the net 7 will resist lateral movement in direction L along crossbar 5 when the net 7 is supported on crossbar 5, because forces applied to the net fastener 10 in lateral direction L will be countered by vertical cord 9 retained in second gap 46 between prongs 42, 42. However, it will be appreciated by a person skilled in the art that it is not necessary for the first engagement element to retain both a horizontal cord and a vertical cord, and that first engagement elements which retain only the peripheral horizontal cord 8, or another horizontal or vertical cord of the net 7, will also work and are intended to be included in the scope of the present disclosure. An example of such an embodiment includes the first engagement element having only one prong 42 extending from surface 26a, which would engage for example a horizontal cord of the net 7.

Although first engagement element 40 is described herein as including two prongs 42, 42 extending from a surface 26a of junction 26 towards the hook 20 and away from handle 30, in some embodiments, it will be appreciated that other first engagement elements may also work and are intended to be included within the scope of the present disclosure. Other examples of first engagement elements may include a single prong 42, and/or one or more ties, clips, wraps, hooks, fingers, channels, gaps or notches cut into the surface 26a of junction 26, or other variations of an engagement element that are known to a person ordinarily skilled in the art. Furthermore, it will be appreciated that the first engagement element 40 may be proximate to other portions of the fastener 10, other than proximate to the junction 26. For example, the first engagement element 40 may be located below the junction 26 somewhere along the length of the handle 30, and furthermore, the first engagement element 40 may extend or protrude from an exterior surface 26b of junction 26 or from an interior or exterior surface 30a, 30b of handle 30. However, in a preferred embodiment the engagement element 40 extends from an interior surface 26a of junction 26, as a cord engaged in the first engagement element 40 may become compressed between the net fastener 10 and the crossbar 5 when mounted on crossbar 5.

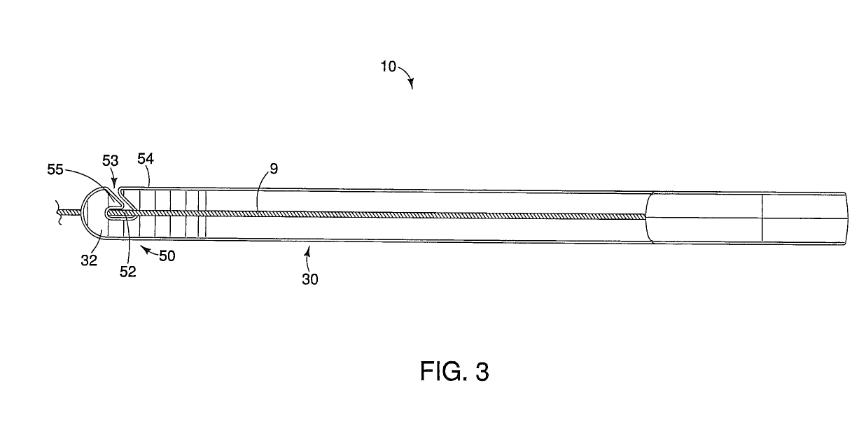

In some embodiments of the present disclosure, a second engagement element 50 is located at, or proximate to, distal end 32 of handle 30, as best seen for example in FIGS. 1 and 3. Second engagement element 50, in some embodiments of the present disclosure, may include a notch 52 having an opening 53 leading from an edge 54 of handle 30 towards notch 52.

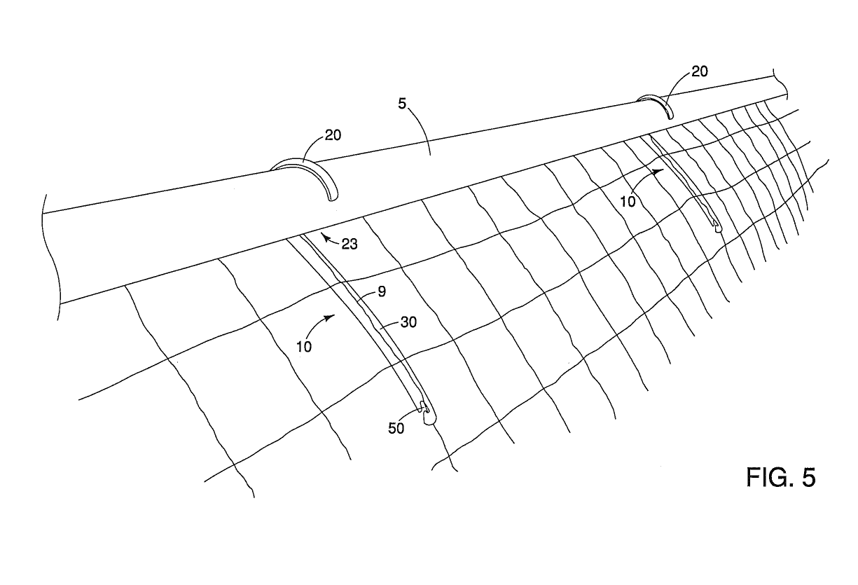

As illustrated for example in FIGS. 3 and 5, a vertical cord 9 of net 7 may be engaged in notch 52 by sliding through opening 53 along edge 54 of the handle 30. In some embodiments, the notch 52 may be approximately V-shaped, with one end of the V-shaped notch 52 leading to the edge 54 of the handle and thereby forming an opening 53 to notch 52. A vertical cord 9 of the net 7 may be received in notch 52 by sliding the cord 9 through opening 53, and a tab 55 formed by notch 52 may assist in retaining the cord 9 within notch 52. Although the second engagement element may consist of a notch 52 as described herein, it will be appreciated by a person skilled in the art that other forms of second engagement elements for engaging and retaining either a vertical or horizontal cord of the net 7 may also work and are intended to be included in the scope of the present disclosure. Other such engagement elements may include, for example, notches having shapes other than a V-shape and/or extending from other edges of the distal end 32 or handle 30, and/or the engagement element may further include one or more prongs ties, clips, wraps, hooks, fingers, channels, gaps or notches cut into the handle 30 or distal end 32, or other variations of a second engagement element for engaging a cord of a net that are known to a person ordinarily skilled in the art.

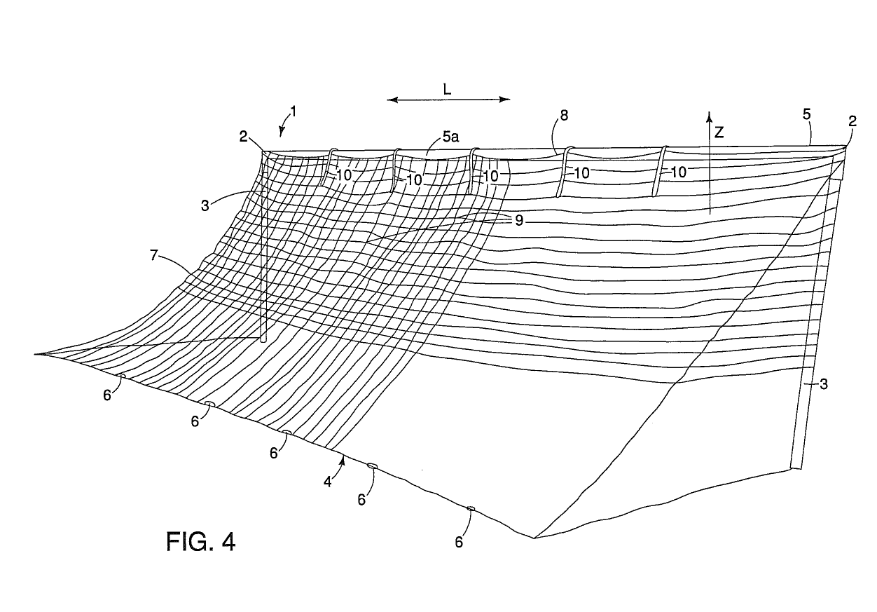

The hook 20 of the net fastener 10 defines an opening 23 leading to an open loop 21. Once cords of the net are engaged with the first and second engagement elements 40, 50, the hook engages a crossbar 5 of a net frame 1, the horizontal crossbar 5 typically being supported by two vertical supports 3, 3, such as shown in FIGS. 4 and 5. Specifically, in some embodiments of the present disclosure, the crossbar 5 is received through the opening 23 leading to the open loop 21 of hook 20. In some embodiments, the width X of opening 23 may be less than a width of a cross section of the horizontal crossbar 5 and the hook 20 may be made of a resilient material, such as a plastic or metal, which allows the free end 22 of hook 20 to move away slightly from handle 30 when engaging the hook 20 around crossbar 5, thereby allowing the width X of opening 23 to expand slightly so as to receive the width of the cross section of the crossbar 5. Advantageously, the free end 22 of resilient hook 20 will urge towards its original position once the hook 20 is engaged on crossbar 5, thereby slightly tightening the hook 20 around crossbar 5 and further enhancing the engagement of the hook 20 with crossbar 5. Additionally, as previously mentioned, for embodiments of net fastener 10 including first engagement elements including one or more prongs 42, the tightening of the resilient hook 20 will also urge the free ends 43 of prongs 42 towards the interior surface 20a of hook 20 to further narrow the neck 45, thereby facilitating retention of the horizontal net cord 8 within first gap 44. This arrangement of the resilient hook 20, in some embodiments, also provides for a hook 20 that may be used to engage various different types of crossbars, including crossbars having cross sections of various shapes and sizes (such as circles, rectangles or squares of varying widths).

In some embodiments, the hook 20 may be slightly elliptically shaped, extending 180 degrees or more from the handle end 24 to the free end 22 of hook 20, as best seen for example in FIGS. 1 and 2. Preferably, the hook may extend more than 180 degrees and may form a partial ellipsis having dimensions of approximately 4 inches wide by 3.5 inches height. For example, without intending to be limiting, the partial ellipsis of the hook 20 may have dimensions of a height 1 of approximately 3.9 inches and a width K of approximately 3.6 inches, as illustrated in FIG. 2. In the applicant's experience, these dimensions are suitable for engaging with crossbars having cross-sectional widths in the range of 3.5-5 inches, and this configuration of the hook 20 advantageously remains engaged on the crossbar 5, even when impacted by players or balls during a game. However, it will be appreciated by a person skilled in the art that other dimensions and configurations of the hook 20 are possible, including variations in the shape and dimensions so as to accommodate various different types of crossbars, and are intended to be included in the scope of this disclosure.

The handle 30 may be of varying lengths. In some embodiments of the net fastener, including those to be used for hanging a soccer net on a horizontal crossbar located approximately eight feet above the ground, the handle 30 preferably has a length Y sufficient to enable most people to stand on the ground, without additional support or boosting from the ground, and engage the hook 20 over crossbar 5 by holding the distal end 32 of handle 30 and extending the hook 20 towards the crossbar. For example, without intending to be limiting, the length Y of handle 30 may be in the range of approximately 6 to 19 inches. In a preferred embodiment, the length Y of handle 30 may be substantially 13 inches. In other embodiments, the handle 30 may be of variable length, for example a telescoping handle that is capable of extension or retraction. In some embodiments, the handle 30 may include an extension or an attachment which is releasably secured to the distal end of the handle 32 to temporarily extend the length of handle 30 when securing the fastener 10 to a crossbar 5, and then detached from the distal end of the handle 32 once the fastener 10 is in place.

In some embodiments, the surface of distal end 32 of handle 30 may optionally further include a series of depressions or ridges 34, providing for a hand grip on the distal end 32 of handle 30. For example, the depressions 34 may be sized and shaped so as to receive the fingers of a person grasping the distal end 32.

Optionally, in some embodiments of the present disclosure, the net fastener 10 may further include a utility hook 60, which may protrude at an angle from an exterior surface 26b of junction 26 and away from handle 30. Utility hook 60, in some embodiments, may form a cavity 62 for engaging a cord of the net 7. Utility hook 60 may be used, for example, to engage and manipulate a peripheral horizontal cord 8 of the net 7 in order to mount the net 7 onto the corners 2, 2 of net frame 1, by temporarily engaging a cord of the net 7 within cavity 62 during the manipulation process, and then once the net cord has been satisfactorily positioned, the net cord is disengaged from utility hook cavity 62. Although the utility hook 60 is illustrated as protruding from exterior surface 26b of junction 26 between hook 20 and handle 30, it will be appreciated by a person skilled in the art that the utility hook 60 may be positioned on other portions of the net fastener, such as along the interior or exterior surfaces 30a, 30b of handle 30, or an edge 54 of handle 30, or an exterior surface 20b of hook 20. For net frames 1 having hooks, bolts, or other fastening points, the utility hook 60 may also be used to engage and manipulate net cords into engagement with such fastening points existing on the net frame 1.

A plurality of net fasteners 10 may be utilized to mount a net 7 onto a horizontal crossbar 5. In some embodiments, referring to FIGS. 4 and 5, the net 7 may be fastened to the crossbar 5 by engaging one or more cords of the net 7 (such as a peripheral horizontal cord 8 and a vertical cord 9) in the first engagement element 40 and the second engagement element 50 of a plurality of net fasteners 10. Once the net cords are so engaged with the net fasteners, each net fastener 10 may be mounted to the crossbar 5 by grasping the handle 30 and lifting hook 20 towards crossbar 5, then sliding the opening 23 of hook 20 over crossbar 5. While mounting the plurality of net fasteners 10 to crossbar 5, the net fasteners 10 may be substantially evenly spaced apart from each other so as to tension the horizontal cord 8 of net 7 along the crossbar 5. In some embodiments, the net fasteners may be positioned approximately every four to five feet along the span of the crossbar. For example, without intending to be limiting, a standard sized soccer net frame may be 8 feet high by 24 feet wide, and thus the Applicant observes that using five net hangers, evenly spaced apart from each other and from the corners 2 of frame 1 by approximately four feet, supports the net 7 so as to eliminate gaps between the net 7 and the horizontal crossbar 5. However, more or less net fasteners 10 may be used to hang a net 7 along a crossbar 5, including crossbars 5 of varying lengths and dimensions. In FIG. 5, some of the horizontal cords 8 and vertical cords 9 are omitted for clarity.

Once the hooks 20 of each net fastener 10 are engaged on the crossbar 5 of net fame 1, an additional net fastener 10 may optionally be used as a utility tool to lift the corners of the net 7 onto the corners 2 of net frame 1, or onto any other fasteners or attachments on the net frame 1, which may include for example fasteners or attachments along the vertical supports 3 of net frame 1. A further option may be to secure an edge 4 of net 7, opposite the peripheral horizontal cord 8 of net 7, to the ground supporting the net frame 1, for example by using a plurality of ground stakes 6. In some embodiments wherein the edge 4 of net 7 is secured to the ground, advantageously a tension is introduced to the vertical net cords 9 supported in the first and/or second engagement elements 40, 50 of the net fasteners 10, which tension is transmitted directly to the hook 20 and not distributed to the horizontal cord 8 on either side of the hook 20, thereby assisting with keeping the peripheral horizontal cord 8 relatively taut along the crossbar 5 and thereby reducing or eliminating the net 7 sagging below the crossbar 5 between the net fasteners 10.

To remove the net 7 from the net frame 1, the net fasteners 10 may be disengaged from the crossbar 5 by applying a vertically upward force to the handle 30 of each net fastener 10 substantially in direction Z, thereby causing the crossbar 5 to pass through hook opening 23. The net fastener 10 may then be disengaged from the net 7, or optionally, the net fastener 10 may remain engaged with net 7 so as to avoid having to repeat the step of engaging the first and second engagement elements with the net cords for the next use of the net fasteners 10. For those embodiments having a neck 44 leading to a first gap 45, within which gap a horizontal cord of the net may be retained, the neck 44 may assist with retaining a horizontal cord 8 of the net 7, facilitating the continued engagement of the net 7 with the net fastener 10 when the net is not in use.

In other embodiments of the present disclosure, net fastening kits for fastening a net 7 to a net frame 1 may be provided. In some embodiments, a plurality of net fasteners 10 is provided in a kit. In other embodiments, the plurality of net fasteners may include five net fasteners, for example to hang a net on a net frame 1 having a crossbar 5 that is substantially 24 feet long. In other embodiments, the kit may include six fasteners for hanging a net on a crossbar that is substantially 24 feet long, whereby five of the net fasteners 10 may be spaced apart approximately four feet from each other and from each of the two corners 2 of the net frame 1, and an extra net fastener 10 having a utility hook 60 may be used to lift and manipulate other portions of the net 7 for engagement on the corners 2 of net frame 1 and/or other fasteners or attachment points on net frame 1.

What is claimed is:

1. A net fastener for releasably fastening a net to a horizontal crossbar, comprising:
a hook defining a loop, the hook having a free end, a handle end, and defining an opening leading to the loop,
an elongate handle extending from the handle end of the hook,
a first engagement element proximate the handle end of the hook,
the handle having a second engagement element separated from the first engagement element by a length of the handle,
wherein the first engagement element engages at least one of a vertical cord and a first horizontal cord of the net and the second engagement element engages at least one of a second horizontal cord and the vertical cord of the net.

2. The net fastener of claim 1 wherein the first engagement element includes a prong, the prong protruding substantially from a junction between the hook and the handle towards the loop and away from the handle.

3. The net fastener of claim 1 wherein the first engagement element releasably engages both the first horizontal cord and the vertical cord of the net and the second engagement element releasably engages the vertical cord of the net.

4. The net fastener of claim 3 wherein the first engagement element includes first and second prongs, the first and second prongs extending substantially parallel to each other and protruding from the handle end of the hook and away from the handle, the first and second prongs defining a first gap between an interior surface of the hook and the first and second prongs and a second gap between the first and second prongs,
wherein the first engagement element engages the first horizontal cord in the first gap and the vertical cord in the second gap.

5. The net fastener of claim 3 further including a distal end of the handle, distal from the hook, the distal end having a bottom edge and first and second edges, wherein the second engagement element includes a notch in the distal end, the notch extending from an edge of the distal end selected from a group comprising: the bottom edge, the first edge, the second edge.

6. The net fastener of claim 1 wherein the hook is resilient and the opening of the hook has a width that is less than a width of a cross-section of the crossbar.

7. The net fastener of claim 1 wherein the net fastener further includes a utility hook protruding from a surface selected from a group comprising: the handle, an interior surface of the hook, an exterior surface of the hook, a distal end of the handle.

8. The net fastener of claim 4 wherein an opening to the first gap defined between distal ends of the first and second prongs and the interior surface of the hook has a width that is less than a width of the first gap.

9. The net fastener of claim 1 wherein the handle has an interior surface coextensive with an interior surface of the hook, wherein the interior surface of the handle includes a camber extending substantially between the distal end of the handle and the handle end of the hook.

10. The net fastener of claim 1 wherein the handle includes an adjustable length adjustable between a retracted length and an extended length.

11. A method for releasably fastening a net to a horizontal crossbar, comprising:
engaging a first engagement element of each net fastener of a plurality of net fasteners with a peripheral horizontal cord of the net,
engaging the second engagement element of each net fastener with a second cord of the net, the second cord vertically spaced apart from the peripheral horizontal cord, and
engaging a hook of each net fastener with the horizontal crossbar.

12. The method of claim 11 further comprising the step of positioning each net fastener along the horizontal crossbar at a distance apart from each adjacent net fastener.

13. The method of claim 12 further comprising the step of:
securing a horizontal peripheral edge of the net, opposite the horizontal peripheral cord of the net, to a horizontal surface located underneath the horizontal crossbar.

14. The method of claim 13 wherein the step of engaging a plurality of net fasteners to a peripheral horizontal cord of the net further includes engaging a vertical cord selected from a plurality of vertical cords with the first engagement element of each net fastener of the plurality of net fasteners, and
wherein the step of securing the horizontal peripheral edge of the net further includes securing the horizontal peripheral edge of the net to the horizontal surface located beneath the crossbar at a position proximate to each selected vertical cord of the plurality of vertical cords.

15. The method of claim 11 wherein at least an additional net fastener of the plurality of net fasteners further includes a utility hook protruding from a surface of each net fastener at an angle of less than 90° towards an apex of the hook of the fastener, the method further comprising the steps of:
engaging the utility hook of the additional net fastener of the plurality of net fasteners with the peripheral horizontal cord of the net at a position proximate to a first corner of a net frame,
mounting the peripheral horizontal cord of the net to the first corner of a net frame, the first corner formed between the horizontal crossbar and a first vertical support,
disengaging the utility hook of the additional net fastener from the peripheral horizontal cord of the net,
engaging the utility hook of the additional net fastener of the plurality of net fasteners with the peripheral horizontal cord of the net at a position proximate to a second corner of the net frame,
mounting the peripheral horizontal cord of the net to the second corner of the net frame, the second corner formed between the horizontal crossbar and a second vertical support,
disengaging the utility hook from the peripheral horizontal cord of the net.

16. The method of claim 11 further comprising the step of:
applying a force to a distal end of the handle towards the crossbar so as to disengage the hook and the net from the crossbar.

17. The method of claim 11 wherein the plurality of net fasteners includes five net fasteners.

18. The method of claim 15 wherein the plurality of net fasteners includes six net fasteners, wherein the hooks of five of the net fasteners engage the horizontal crossbar and one of the six net fasteners is the additional net fastener used to mount the peripheral horizontal cord of the net to each corner of the first and second corners of the net frame.

19. A kit for releasably fastening a net to a horizontal crossbar, comprising:
at least five net fasteners, each fastener of the at least five net fasteners comprising a hook, an elongate handle extending from the hook, a first engagement element proximate a junction between the hook and the handle and a second engagement element separated from the first engagement element by a length of the handle.

20. The kit of claim 19 further including a plurality of stakes for releasably securing a peripheral edge of the net to a horizontal surface located at a vertical distance beneath the horizontal crossbar,
wherein each net fastener of the at least five net fasteners further includes a utility hook protruding from the hook of the net fastener, and
wherein the at least five net fasteners includes six net fasteners.
